(19) United States
(12) Patent Application Publication
(10) Pub. No.: US 2018/0057284 A1
(43) Pub. Date: Mar. 1, 2018

(54) Computer Optimized Mixed Parcel Loading Equipment

(71) Applicant: Siemens Industry, Inc., Alpharetta, GA (US)

(72) Inventors: Michael D. Carpenter, Arlington, TX (US); Saul Stawar, Dallas, TX (US)

(21) Appl. No.: 15/252,768

(22) Filed: Aug. 31, 2016

(51) Int. Cl. B65G 57/03; B65G 61/00

(52) U.S. Cl. CPC B65G 57/03; B65G 61/00

(57) ABSTRACT

A parcel processing system and method. A method includes receiving a plurality of items to be sorted. The method includes receiving a plurality of parcels by a parcel processing apparatus and producing parcel data corresponding to each of the parcels, the parcel data including physical dimensions and a weight for each parcel. The method includes designing a virtual stack of the plurality of parcels to occupy a working volume according to the parcel data by a volumetric modeling engine. The method includes building a physical stack of the parcels that corresponds to the virtual stack by a working volume builder, wherein the physical stack is thereafter transferred into the working volume in a container.

### TECHNICAL FIELD

The present disclosure is directed, in general, to parcel processing techniques.

### BACKGROUND OF THE DISCLOSURE

Loading packages for bulk transportation is a significant bottleneck in the speed of package delivery and the cost of shipping. A typical trailer contains 1000-5000 packages that are loaded manually at a rate of some 500-700 pieces per hour. The size, shape and weight of individual packages significantly influences the trailer's capacity and the efficiency of the operator.

### SUMMARY OF THE DISCLOSURE

Various disclosed embodiments include parcel processing system and method. A parcel processing system includes a parcel processing apparatus configured to receive a plurality of parcels and to produce parcel data corresponding to each of the parcels, the parcel data including physical dimensions and a weight for each parcel. The parcel processing system includes a volumetric modeling engine (VME) configured to design a virtual stack of the plurality of parcels to occupy a working volume according to the parcel data. The parcel processing system includes a working volume builder configured to build a physical stack of the parcels, on a rack, that corresponds to the virtual stack, wherein the physical stack is thereafter transferred into the working volume in a container, on a movable rack or otherwise.

In various embodiments, the working volume builder includes a three-axis gantry apparatus with an end-effector that is configured to move the parcels to build the physical stack of the parcels. In various embodiments, the working volume builder includes a plurality of positioning drives with conveyor surfaces that are configured to move the parcels to build the physical stack of the parcels. In various embodiments, the VME builds a separate virtual stack for each of a plurality of sort destinations. In various embodiments, the working volume is a three-dimensional space for the physical stack of parcels, and the working volume is a portion of a total loading volume of the container. In various embodiments, the parcel processing system is configured to perform destination sorting to sort the parcels according to the parcel data. In various embodiments, the parcel processing system is configured to perform sequence buffering to place the parcels in a sequence to build the physical stack. In various embodiments, the parcel processing system is configured to form a random access queue of the parcels. In various embodiments, the parcel processing system includes a carousel sorter. In various embodiments, the VME designs the virtual stack according to rules including at least one of a total loading volume, a queue depth, a targeted volumetric efficiency, or a working volume. In various embodiments, the VME designs the virtual stack according to preferences including at least one of a preference for placement of largest items, a preference for placement of heaviest items, or a compression factor.

In another embodiment, a method includes receiving a plurality of items to be sorted. The method includes receiving a plurality of parcels by a parcel processing apparatus and producing parcel data corresponding to each of the parcels, the parcel data including physical dimensions and a weight for each parcel. The method includes designing a virtual stack of the plurality of parcels to occupy a working volume according to the parcel data by a volumetric modeling engine (VME). The method includes building a physical stack of the parcels, on a rack, that corresponds to the virtual stack by a working volume builder, wherein the rack is configured to transport the physical stack into the working volume in a container.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 illustrates an example of processing parcels in accordance with disclosed embodiments;

FIG. 3 illustrates a container where a total loading volume of the container is segmented into working volumes in accordance with disclosed embodiments;

FIG. 4 illustrates one example of the structure and operation of a working volume builder in accordance with disclosed embodiments;

FIG. 5 illustrates a more detailed view of portions of a working volume builder in accordance with disclosed embodiments;

FIG. 6 illustrates an example of a rack being removed from the working volume builder in accordance with disclosed embodiments; and

FIG. 7 illustrates an example of a rack being unloaded within a container in accordance with disclosed embodiments.

### DETAILED DESCRIPTION

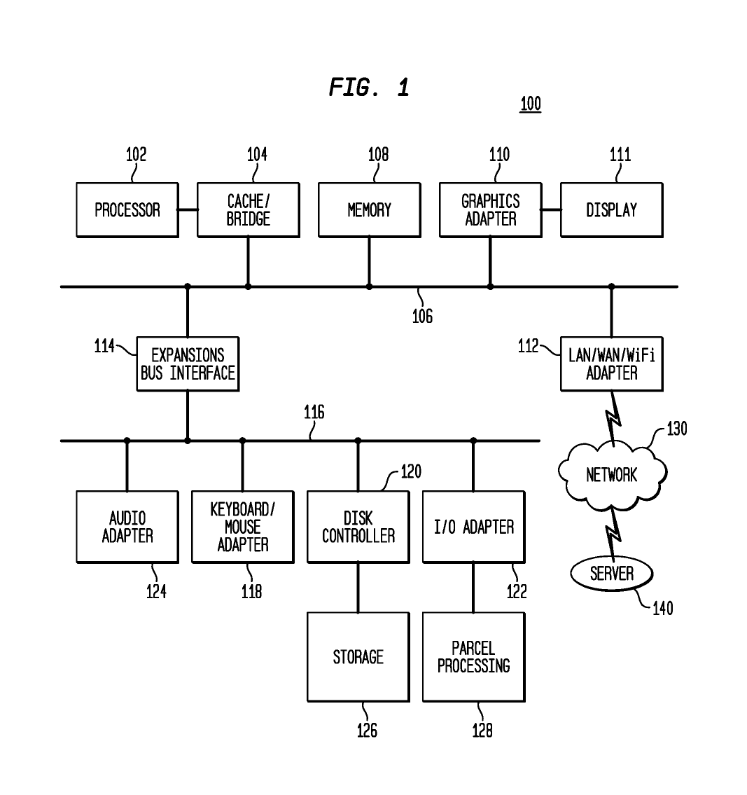

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

A process for loading parcels into a trailer or other container is typically based on a telescopic conveyer that transports the packages to the loading point in the shipping trailer, and one or two operators that take the packages from this conveyer and place them on the floor of the trailer or on top of other packages. The labor conditions of these operators is not very ergonomic, as they have to lift packages weighing up to 32 kg each, and then turn their body in order to place the packages in the trailer. A “parcel,” as used herein, refers to any package, box, or other item being mailed or processed as described herein.

Packages are rarely uniform in size, weight, or shape, and there may be large bags containing smaller packages. Heavier and unwieldy freight items are also commingled with these packages and can make up a significant portion of total items.

The loading approach is key to achieve a stable package stack which will not shift while the truck is driving, resulting in damaging the packages. To achieve this stable stack, loading operators may employ one or more different techniques.

In some cases, heavy packages are placed directly on the floor of the trailer, with lighter packages in top. In other cases, large and heavy packages are used to build “separation walls” perpendicular to the driving direction of the truck, and smaller and lighter objects are placed between these walls. In other cases, nets, ropes, and bars are occasionally used to achieve additional stability.

A higher volumetric efficiency in the loaded portion of the trailer results in a more stable package stack that is less likely to shift and potentially damage packages.

Disclosed embodiments include systems and methods for strategic parcel loading that loads parcels in to the trailer or container in an efficient and stable manner.

FIG. 1 depicts a block diagram of a data processing system 100 in which an embodiment can be implemented, for example as a control system for a parcel processing system as described below, and can be configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

I/O adapter 122 can be connected to a parcel processing system 128, as described herein, to dimension, sort, transport, and otherwise process the parcels for loading in accordance with the various embodiments described herein.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. LAN/WAN/Wireless adapter 112 can also communicate with packages as described herein, and perform other data processing system or server processes described herein. Data processing system 100 can communicate over network 130 with one or more server systems 140, which are also not part of data processing system 100, but can be implemented, for example, as separate data processing systems 100. A server system 140 can be, for example, a central server system at a central mail processing facility.

Disclosed embodiments can employ fully-automated sorting and distribution system to provide preknowledge to an automatic loading system. In such an environment, each item being processed is scanned to determine its unique identifier, its destination, its dimensions, its shape, and its weight, prior to sorting according to destination. The availability of this information is important to automatic loading.

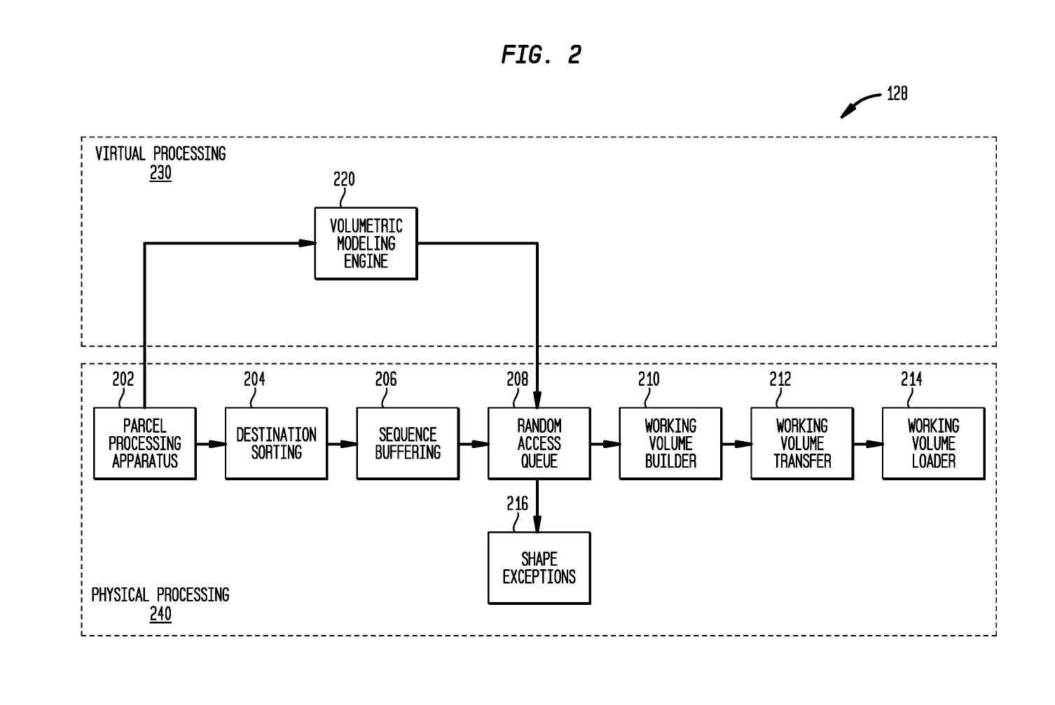

FIG. 2 illustrates an example of processing parcels in accordance with disclosed embodiments that can be performed, for example, by a parcel processing system 128 under control of a data processing system 100 as described herein, generically referred to as the “system” below.

In this example, during physical processing 240, the system receives parcels at parcel processing apparatus 202. Parcel processing 202 performs such functions as determining physical characteristics of each parcel, such as physical dimensions and weight. Parcel processing apparatus 202 can also scan or image each parcel to determine such information as the parcel destination, the parcel origin, proper payment indicia, parcel identifiers such as barcodes or otherwise, or other information. In some cases, physical dimensions are directly measured using physical, light, or other sensors, and in other cases, the physical dimensions are determined from the images. In some cases, the weight of each parcel is determined by directly weighing each parcel, and in other cases, the weight can be determined or estimated using such factors as the physical dimensions, indicia on the parcel, a parcel profile, previously-assigned weights for specific parcels, or otherwise. The data collected at parcel processing apparatus 202 is referred to herein as “parcel data.” During each subsequent step in this process, the system can track the specific location of each parcel so that each parcel can be individually moved and processed as described herein. Parcel processing apparatus 202 can be implemented, for example, as a dimensioning tunnel scanner, and refers to the apparatus that receives items into the local processing operation as described herein, performing functions as described.

The parcel data is transmitted to a volumetric modeling engine (VME) 220, described in more detail below, for virtual processing 230.

The system can perform destination sorting 204 to specific sort destinations according to the parcel data. In specific embodiments, this destination sorting 204 is sorting to the proper loading door for the destination trailer or other container.

The system can perform sequence buffering on each parcel for each sort destination using a sequence buffer 206. The sequence buffering is forming in a buffer for each sort destination, a contiguous sequence of parcels whose sequence may be altered to match the sequence provided by the VME as described herein.

As the parcels are being physically processed, the VME 220 is performing virtual processing 230. VME 220 designs a virtual stack of parcels for each sort destination according to the parcel data for each parcel and a working volume into which the stack is to be placed. For example, for a given sort destination, VME 220 can design a virtual stack of parcels with heavier or larger parcels at the bottom, and lighter and smaller parcels at the top. The virtual stack can be designed to maximize space efficiency according to the parcel data so that all space, within the dimensions of the working volume, is efficiently packed with the parcels. The “working volume” refers to the three-dimensional space for the assembled (or being-assembled) stack of parcels according to the stack designed by VME 220.

Where the parcel data for a given parcel, such as its shape, indicate that the parcel cannot be well placed in a stack of parcels designed by VME 220, that parcel can be moved to shape exceptions 216 for “exception” or manual processing.

The system forms a random access queue 208 for each sort destination. The random access queue 208 allows individual parcels in each queue to be advanced in any order to the working volume builder 210 according to the stacks designed by the VME 220.

The system builds a stack of parcels for each sort destination at working volume builder 210, according to the virtual stack designed by VME 220, to occupy a specific working volume. The system transfers the stack for the working volume for loading using working volume transfer 212.

The system loads the stack for the working volume into the container using working volume loader 214.

The steps above, and the particular hardware that implements each step, may be combined or modified as desired for particular implementation. For example, in some embodiments, the destination sorting 204, sequence buffering 206, and random access queue 208 can be implemented within a carousel sorter designed with appropriate capacity for moderate buffering of each destination. The depth of the buffer (and total capacity of the sorter) may be managed or defined by VME 220 for the typical spectrum of parcels being processed. Buffering may also be used to “smooth” and coordinate utilization at loading points.

VME 220 can determine the volumetrically optimal sequence and arrangement of items in each designed stack using rules. The rules can include, for example, a total loading volume, a queue depth (the contiguous number of items in their original sequence within which sequence may be altered), a targeted volumetric efficiency (the maximum unused space within the working volume), a working volume (the space and shape in which items may be arranged),

VME 220 can accommodate limitations in physical characteristics that will be handled by the system, such as the definition of processing exceptions which will be rejected by the automatic system, and will be handled as exceptions or by manual processing. VME 220 can design stacks according to selected preferences, such as preference for placement of largest items (e.g., larger items nearer the floor), preference for placement of heaviest items (e.g., heavier items nearer the floor), or compression factor (e.g., targeted compression to stabilize the load during shipment).

VME 220 models arrangements of a contiguous series of parcels to achieve the most efficient possible volumetric efficiency within a working volume, which represents a subset of the total loading volume. FIG. 2 shows the relationship between working volumes and the total loading volume. Working volumes in this example are segments of volume that extend across the container being loaded, but smaller segments may be employed, which may not extend across the container.

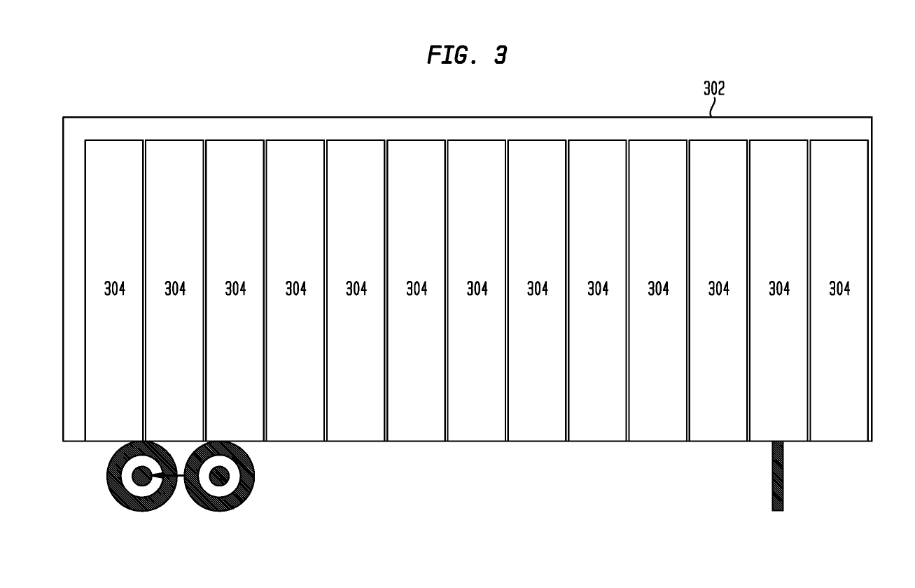

FIG. 3 illustrates a container 302 (in this case, a trailer). The total loading volume of container 302 is segmented into working volumes 304. VME 220 provides working volume solutions, within which the original sequence of parcels must be altered to the sequence of items as they must be placed within the working volume. Rules or preferences such as those discussed above may require the VME 220 to place larger, heavier items lowest within the working volume 304, and these rules may represent a compromise in the ideal volumetric efficiency achieved among a contiguous sequence of items that will compose the working volume. In other words, the number of items within the working volume 304 may be reduced from the ideal to a lower number in order to achieve loading rules or preferences.

The VME 220 must often reserve some of the volume of the container 302 for exceptions: irregularly-shaped items, and other items that are incompatible with automation, including the processes described herein.

In various embodiments, the depth (or height, in cases where the stack is designed or built in a horizontal orientation before loading as described herein) of the working volume is based on the largest number of items that can be manipulated at once, such that a stable structure is created for the working volume. The width of the working volume is limited by the compression of the working volume and the width of the opening into the container (the doorway). Significantly narrowing between the width of the container and the width of the opening reduce the possibility of creating a structure under compression by the side walls of the container. This is typically determined by the type of door(s) used to close the opening, so-called “roll-up” doors represent the worst typical case, with so-called “bat-wing” doors being optimal, with almost no narrowing. The height of the working volume is limited by the height of the container, and any space required to manipulate the volume into position in the container, such as lifting a horizontal stack into place in the container as a vertical stack.

As described above with respect to FIG. 2, the physical processing of items includes sequence buffering, a contiguous sequence of items whose sequence may be altered to match the sequence provided by VME 220 for building the stack. A random access within this buffer is used to re-sequence the physical items that will compose the working volume. Since the space required to buffer item sequences may be very tight and random access within sequences expensive, it is possible to create smaller working volumes (thus, smaller buffers). The exemplary embodiments described herein describe working volumes that are constructed as “walls” within the container volume, extending from wall to wall, from the floor to nearly the ceiling, but smaller working volumes can be designed by the system.

The working volume builder 210 can arrange a sequence of items in up to three dimensions as specified by VME 220 for the working volume 304 in question. As noted above, it may be an advantage to build (assemble) the stacks for the working volumes laying level (in a horizontal orientation) rather than standing in the vertical orientation in which they will be situated once loaded.

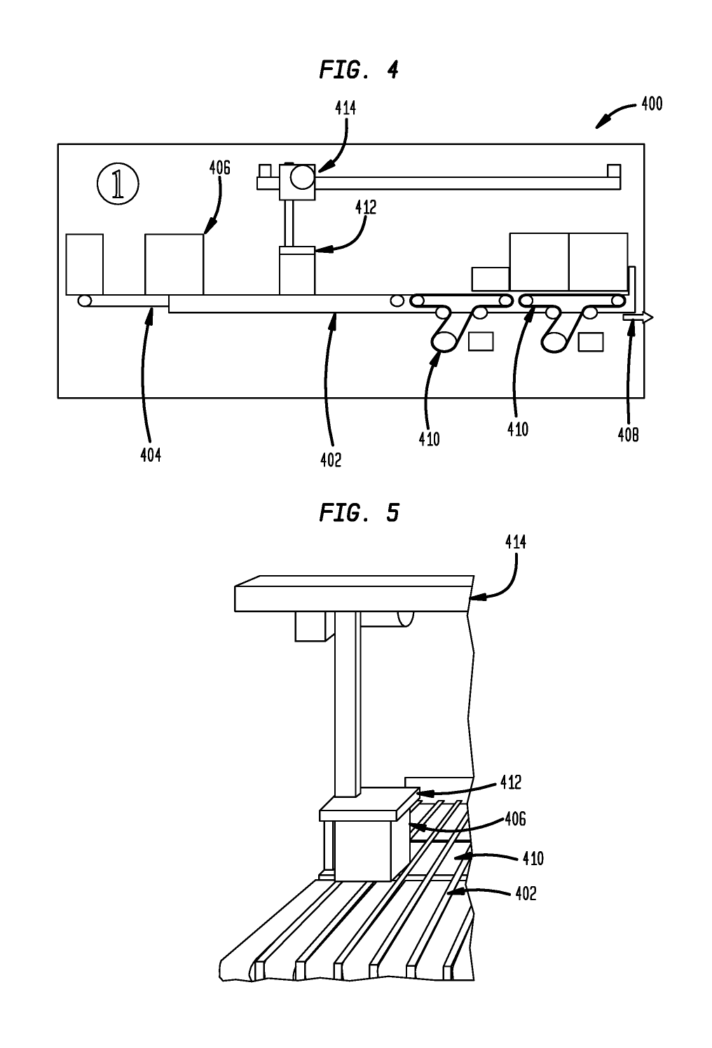

FIG. 4 illustrates one example of the structure and operation of a working volume builder 400 in accordance with disclosed embodiments. This working volume builder is placing items on a rack 402, which is subsequently used to reposition the working volume into the appropriate orientation and position within the total loading volume. In this example, oriented, sequenced parcels 406 are conveyed on belts 404 to their position on the rack 402. As the rack 402 is loaded, it is shifted to maintain a consistent loading point on the working volume builder, as indicated by arrow 408.

Positioning drives 410, segments of conveyor small enough to allow individual items to be positioned, are beneath the loading point. The positioning drives 410 (including conveying surfaces) move parcels 406 on the loading point to the edge of the accumulated working volume. A gantry-mounted end-effector 412 is suspended above the loading point, and is movable in three dimensions by gantry apparatus 414. The end-effector 412 may be positioned anywhere within the loading point of the working volume. The end-effector 412 is used to index items side-to-side along the rack so that the positioning drives 410 may advance or position them to the precise loading point on the accumulated stack being built on rack 402 for the working volume. The end effector 412 is also capable of lifting small, items so that they may be stacked one on top of the other within the loading point of the stack being built on rack 402 for the working volume.

FIG. 5 illustrates a more detailed view of portions of working volume builder 400. Three-axis gantry apparatus 414 can use end-effector 412 to shift, stack, and otherwise move parcels 406. The support structure of rack 402 can be below the level of the conveying surfaces of positioning drives 410 while the stack is being built.

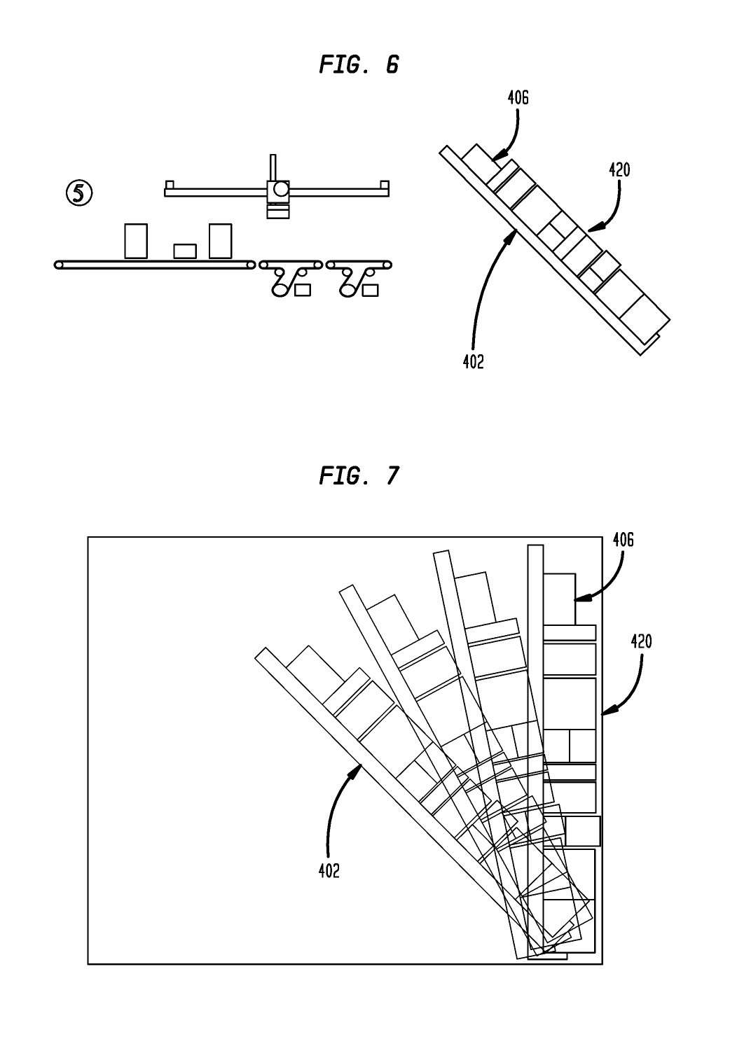

FIG. 6 illustrates rack 402 being removed from the working volume builder 400 in accordance with disclosed embodiments. In this example, the stack 420 of parcels 406 has been built to fill a working volume 304, and rack 402 can transport the stack 420 as working volume transfer 212. In transfer, rack 402 can be moved manually or by an automated loading system.

FIG. 7 illustrates rack 402 being unloaded within a container in accordance with disclosed embodiments. In this example, the stack 420 of parcels 406 is raised to a vertical orientation on rack 402 within the appropriate working volume 304 in a container 302 in a process for working volume loader 214. Rack 402 can then be removed and re-loaded with its next stack by working volume builder 210. During unloading into working volume 304, rack 402 can be moved manually or by an automated loading system.

In some embodiments, to accommodate the relatively low utilization at individual loading points, the functions shown in FIG. 2 (and described above) of “working volume builder 210,” “working volume transfer 212,” and “working volume loader 214” can be implemented as a single, movable machine that is transported between loading points, as directed by the VME 220. When a working volume sequence is available for loading, the VME 220 directs the working volume loader machine to the appropriate loading point to build the working volume, transfer it, and load it. In this way, one working volume loader serves multiple loading points; the ratio of loaders to loading points depends on various system parameters (the ratio between the rate at which working volumes are available versus the rate at which they can be loaded, etc.).

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art. Further, the various steps described herein can be omitted or performed repeatedly, successively, concurrently, in a different order, or combined in various embodiments.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke of 35 USC §112(f) unless the exact words “means for” are followed by a participle.

1. A parcel processing system, comprising:
a parcel processing apparatus configured to receive a plurality of parcels and to produce parcel data corresponding to each of the parcels, the parcel data including physical dimensions and a weight for each parcel;
a volumetric modeling engine (VME) configured to design a virtual stack of the plurality of parcels to occupy a working volume according to the parcel data, wherein the VME designs the virtual stack according to preferences including a targeted compression to stabilize a physical stack of the parcels during shipment;
a working volume builder configured to build the physical stack of the parcels using a three-axis gantry apparatus with an end-effector that is configured to move the parcels into the physical stack, on a rack, that corresponds to the virtual stack, wherein the rack is configured to transport the physical stack into the working volume in a container.

2. (canceled)

3. The parcel processing system of claim 1, wherein the working volume builder includes a plurality of positioning drives with conveyor surfaces that are configured to move the parcels to build the physical stack of the parcels.

4. The parcel processing system of claim 1, wherein the VME builds a separate virtual stack for each of a plurality of sort destinations.

5. The parcel processing system of claim 1, wherein the working volume is a three-dimensional space for the physical stack of parcels, and the working volume is a portion of a total loading volume of the container.

6. The parcel processing system of claim 1, wherein the parcel processing system is configured to perform destination sorting to sort the parcels according to the parcel data.

7. The parcel processing system of claim 1, the parcel processing system is configured to perform sequence buffering to place the parcels in a sequence to build the physical stack.

8. The parcel processing system of claim 1, wherein the parcel processing system is configured to form a random access queue of the parcels.

9. The parcel processing system of claim 1, wherein the parcel processing system includes a carousel sorter.

10. The parcel processing system of claim 1, wherein the VME designs the virtual stack according to rules including at least one of a total loading volume, a queue depth, a targeted volumetric efficiency, or a working volume.

11. (canceled)

12. A method for processing parcels by a parcel processing system, comprising:
receiving a plurality of parcels by a parcel processing apparatus and producing parcel data corresponding to each of the parcels, the parcel data including physical dimensions and a weight for each parcel;
designing a virtual stack of the plurality of parcels to occupy a working volume according to the parcel data by a volumetric modeling engine (VME), wherein the virtual stack is designed according to preferences including a targeted compression to stabilize a physical stack of the parcels during shipment;
building the physical stack of the parcels that corresponds to the virtual stack by a working volume builder that uses a three-axis gantry apparatus with an end-effector to move the parcels into the physical stack, wherein the physical stack is thereafter transferred into the working volume in a container.

13. (canceled)

14. The method of claim 12, wherein the working volume builder includes a plurality of positioning drives with conveyor surfaces that are configured to move the parcels to build the physical stack of the parcels.

15. The method of claim 12, wherein the VME builds a separate virtual stack for each of a plurality of sort destinations.

16. The method of claim 12, wherein the working volume is a three-dimensional space for the physical stack of parcels, and the working volume is a portion of a total loading volume of the container.

17. The method of claim 12, wherein the physical stack is built on a movable rack that is used to transfer the physical rack into the working volume.

18. The method of claim 12, further comprising placing the parcels in a sequence to build the physical stack and forming a random access queue of the parcels.

19. The method of claim 12, wherein the VME designs the virtual stack according to rules including at least one of a total loading volume, a queue depth, a targeted volumetric efficiency, or a working volume.

20. (canceled)
